(19) United States
(12) Patent Application Publication
(10) Pub. No.: US 2026/0089573 A1
(43) Pub. Date: Mar. 26, 2026

(54) Dynamic Subband-Operation Technique

(71) Applicant: Apple Inc., Cupertino, CA (US)

(72) Inventors: Morteza Mehrnoush, Hayward, CA (US); Abdel Karim Ajami, San Jose, CA (US); Ahmad Reza Hedayat, Carlsbad, CA (US); Anuj Batra, Redwood City, CA (US); Wook Bong Lee, San Jose, CA (US); Yan Zhang, Palo Alto, CA (US); Yanjun Sun, San Diego, CA (US); Yong Ho Seok, Cupertino, CA (US); Yong Liu, Campbell, CA (US); Zhou Lan, San Jose, CA (US)

(21) Appl. No.: 19/291,162

(22) Filed: Aug. 5, 2025

Related U.S. Application Data
(60) Provisional application No. 63/698,617, filed on Sep. 25, 2024.
(60) Provisional application No. 63/761,758, filed on Feb. 21, 2025.

(51) Int. Cl. H04W 28/20; H04L 5/00

(52) U.S. Cl. CPC H04W 28/20; H04L 5/0046; H04L 5/0091

(57) ABSTRACT

An electronic device is described. This electronic device can include: an antenna node communicatively coupled to an antenna; and an interface circuit, communicatively coupled to the antenna node. During operation, the interface circuit can generate, addressed to a second electronic device, an ultra-high reliability (UHR) operating mode notification frame. This UHR operating mode notification frame can include: an indication that a DSO mode is enabled; a second indication of whether a DSO parameter is present in the UHR operating mode notification frame; and a third indication of whether a DSO channel allocation is present in the UHR operating mode notification frame. Note that the UHR operating mode notification frame can include an action frame.

### CROSS-REFERENCE TO RELATED APPLICATION

This application claims the benefit of U.S. Provisional Application No. 63/761,758, entitled “Dynamic-Sub-Band-Operation Technique,” by Morteza Mehrnoush, et al., filed Feb. 21, 2025, and U.S. Provisional Application No. 63/698,617, entitled “Dynamic-Sub-Band-Operation Technique,” by Morteza Mehrnoush, et al., filed Sep. 25, 2024, the contents of both of which are hereby incorporated by reference.

### FIELD

The described embodiments relate, generally, to wireless communication among electronic devices, including Dynamic Subband Operation (DSO).

### BACKGROUND

Many electronic devices communicate with each other using wireless local area networks (WLANs), such as those based on a communication protocol that is compatible with an Institute of Electrical and Electronics Engineers (IEEE) 802.11 standard (which is sometimes referred to as ‘Wi-Fi’).

In Wi-Fi communication, a DSO feature enables an access point to schedule narrower bandwidth stations within the larger bandwidth of the access point to improve the spectrum efficiency. An access point can initiate a transmit opportunity (TXOP) with an initial control frame (ICF) with sufficient padding to allow the stations to switch channel(s) outside of the current operating bandwidth (secondary channel) to continue the TXOP. This resource allocation can be on a per-TXOP basis. However, it can be difficult to signal the use and configuration of the DSO feature.

### SUMMARY

In a first group of embodiments, an electronic device is described. This electronic device includes: an antenna node communicatively coupled to an antenna; and an interface circuit, communicatively coupled to the antenna node. During operation, the interface circuit provides or generates, addressed to a second electronic device, an ultra-high reliability (UHR) operating mode notification frame. This UHR operating mode notification frame includes: an indication that a DSO mode is enabled; a second indication of whether a DSO parameter is present in the UHR operating mode notification frame; and a third indication of whether a DSO channel allocation is present in the UHR operating mode notification frame.

Note that the UHR operating mode notification frame can include an action frame.

Moreover, the electronic device can include a non-access point station. Note that the DSO parameter can include at least one of: a DSO padding; a DSO transition delay corresponding to a switching time of the second electronic device to a DSO channel; or a number of DSO channels having a bandwidth of 80 MHz in a bandwidth of 320 MHz. In some embodiments, the DSO channel allocation can include a DSO channel location having a bandwidth of 80 MHz. This DSO channel location can be indicated with a bitmap.

Furthermore, the interface circuit can receive, associated with the second electronic device, a second UHR operating mode notification frame as a response to the UHR operating mode notification frame that confirms the DSO mode enablement.

Additionally, when a basic service set bandwidth equals 160 MHz or a number of DSO channels having a bandwidth of 80 MHz equals 3 in a basic service set bandwidth of 320 MHz, the UHR operating mode notification frame can enable the DSO mode without a subsequent response.

In some embodiments, prior to providing or generating the UHR operating mode notification frame, the interface circuit can receive, associated with the second electronic device, a probe response, an association response or a re-association response. The probe response, the association response or the re-association response can include a UHR operating element. Moreover, the UHR operating element can include: a DSO transition timeout, and a DSO 80 MHz subband assignment. A UHR operating element can be also included in the beacon to announce the related parameters. Note that, after the DSO transition timeout has elapsed, the DSO mode can be enabled.

Furthermore, when a basic service set bandwidth is 320 MHz and a DSO channel bandwidth is 80 MHz, the electronic device can support one or more DSO channel.

Additionally, the UHR operating mode notification frame can specify a DSO channel location having a bandwidth of 80 MHz when the BSS bandwidth is 320 MHz.

In some embodiments, the interface circuit can receive, associated with the second electronic device, a second UHR operating mode notification frame as a response to the UHR operating mode notification frame, where the DSO mode is enabled based at least in part on the second UHR operating mode notification frame. The second UHR operating mode notification frame can specify a DSO 80 MHz subband assignment.

Note that, when the second electronic device stops a transmit opportunity, the interface circuit can return to a primary channel having a bandwidth of 80 MHz or 160 MHz and can experience a blindness having a predefined duration.

Moreover, the interface circuit can puncture one or more channels having a 20 MHz bandwidth and the DSO mode does not use the one or more punctured channels.

Furthermore, the interface circuit can provide or generate, addressed to the second electronic device, an ICF that indicates a clear channel assessment (CCA) criterion.

Additionally, at the end of a transmit opportunity (TXOP), the interface circuit can provide or generate, addressed to the second electronic device, a trigger frame having a duration of 0 and padding corresponding to a DSO transition delay.

In some embodiments, at the end of a TXOP, the interface circuit can provide or generate, addressed to the second electronic device, a physical layer protocol data unit (PPDU) having a network allocation vector (NAV) value of at least a summation of a point control function inter-frame space (PIFS), 20 μs and a DSO transition delay.

Note that the interface circuit can perform beamforming in the DSO mode.

Moreover, the interface circuit can assign a resource unit in the DSO mode for group address frame delivery.

Furthermore, the UHR operating mode notification frame can enable the DSO mode for multiple links.

Additionally, the interface circuit can provide or generate, addressed to the second electronic device, a management or an action frame that enables one or more of: an enhanced multi-link single radio (EMLSR) mode, a dynamic unavailability operation (DUO) mode, or a dynamic power state (DPS) mode at the same time or concurrently with DSO. The DSO mode can operate concurrently with one or more of: the EMLSR mode, the DUO mode or the DPS mode. Note that the management of the action frame can include padding and/or a switching delay, and a transition delay and/or switch back delay to enable one or more of: the EMLSR mode, the DPS mode or the DSO mode. In some embodiments, the interface circuit can: receive, associated with the second electronic device, a buffer status report poll (BSRP) that initiates a TXOP; and provide or generate, addressed to the second electronic device, a multi-station block acknowledgment (M-BA).

Other embodiments provide the second electronic device that performs counterpart operations to at least some of the operations performed by the electronic device.

Other embodiments provide an integrated circuit (such as the interface circuit) for use with the electronic device or the second electronic device. The integrated circuit can perform at least some of the aforementioned operations of the electronic device or the second electronic device.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

In a second group of embodiments, an electronic device is described. This electronic device includes: an antenna node communicatively coupled to an antenna; and an interface circuit, communicatively coupled to the antenna node, and that communicates with a second electronic device. During operation, the interface circuit provides or generates, addressed to the second electronic device, a BSRP or a multi-user request-to-send (MU-RTS) message that includes a DSO ICF, where the DSO ICF indicates initiation of a DSO TXOP.

Note that the interface circuit can receive, associated with the second electronic device and on a DSO channel, at least one of a BSR in response to the BSRP or a clear-to-send (CTS) frame in response to the MU-RTS. The BSR can have a trigger-based PPDU format or the CTS frame can have a non-high throughput duplicate transmission format.

Moreover, the interface circuit can puncture one or more channels having a bandwidth of 20 MHz and the DSO mode does not use the one or more punctured channels. The puncturing can be specified in the DSO ICF, a trigger frame, or an orthogonal frequency division multiple access (OFDMA) preamble.

Furthermore, the interface circuit can perform beamforming in the DSO mode.

Additionally, the interface circuit can assign a resource unit in the DSO mode for group address frame delivery.

Other embodiments provide the second electronic device that performs counterpart operations to at least some of the operations performed by the electronic device. For example, when the MU-RTS represents the DSO ICF, the second electronic device can change a resource-unit allocation to allow the CTS frame to be communicated on the DSO channel. Moreover, when the electronic device stops a transmit opportunity, the second electronic device can return to a primary channel having a bandwidth of 80 MHz or 160 MHz and can experience a blindness having a predefined duration. Furthermore, the second electronic device can receive, from the electronic device, information specifying one or more channels having a bandwidth of 20 MHz that are punctured, where, in the DSO mode, the second electronic device does not use the one or more channels in the DSO mode. Note that the information can be specified in the DSO ICF, a trigger frame, or an OFDMA preamble.

Other embodiments provide an integrated circuit (such as the interface circuit) for use with the electronic device or the second electronic device. The integrated circuit can perform at least some of the aforementioned operations of the electronic device or the second electronic device.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that can be made to the embodiments by one skilled in the art without departing from the spirit and scope of the embodiments. The embodiments will be readily understood by the following detailed description in conjunction with the accompanying drawings, where like reference numerals designate like structural elements.

FIG. 1 is a block diagram illustrating an example of communication between electronic devices.

FIG. 2 is a block diagram illustrating an example of communication between electronic devices.

FIG. 3 is a flow diagram illustrating an example method for providing an ultra-high reliability (UHR) operating mode notification frame using an electronic device of FIG. 1 or 2.

FIG. 4 is a flow diagram illustrating an example method for receiving a UHR operating mode notification frame using an electronic device of FIG. 1 or 2.

FIG. 5 is a drawing illustrating examples of communication between the electronic devices of FIG. 1 or 2.

FIG. 6 is a flow diagram illustrating an example method for providing a buffer status report poll (BSRP) or a multi-user request-to-send (MU-RTS) message using an electronic device of FIG. 1 or 2.

FIG. 7 is a flow diagram illustrating an example method for receiving a BSRP or an MU-RTS message using an electronic device of FIG. 1 or 2.

FIG. 8 is a drawing illustrating examples of communication between the electronic devices of FIG. 1 or 2.

FIGS. 9-11 are drawings illustrating examples of a Dynamic Subband Operation (DSO) operating mode notification element.

FIGS. 12-14 are drawings illustrating examples of communication between the electronic devices of FIG. 1 or 2.

FIG. 15 is a drawing illustrating an example of an action frame during communication between the electronic devices of FIG. 1 or 2.

FIGS. 16-22 are drawings illustrating examples of communication between the electronic devices of FIG. 1 or 2.

FIG. 23 is a drawing illustrating an example of a DSO operating mode notification element.

FIG. 24 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

An electronic device is described. This electronic device can include: an antenna node communicatively coupled to an antenna; and an interface circuit, communicatively coupled to the antenna node. During operation, the interface circuit can provide or generate, addressed to a second electronic device, a UHR operating mode notification frame. This UHR operating mode notification frame can include: an indication that a DSO mode is enabled; a second indication of whether a DSO parameter is present in the UHR operating mode notification frame; and a third indication of whether a DSO channel allocation is present in the UHR operating mode notification frame. Note that the UHR operating mode notification frame can include an action frame. For example, providing the UHR operating mode notification frame can involve transmitting the UHR operating mode notification frame to the second electronic device, while generating the UHR operating mode notification frame can involve creating the UHR operating mode notification frame.

By communicating the UHR operating mode notification frame, these communication techniques can facilitate configuration of the DSO mode. This capability can enable the use of bandwidth puncturing and/or beamforming in the DSO mode. In these ways, the communication techniques can improve the user experience when using the electronic device and/or the second electronic device.

In the discussion that follows, a user can include: an individual, an organization, a company, a governmental agency, a for-profit business entity, a not-for-profit entity, or a group of one or more individuals.

Note that the communication techniques can be used during or with wired or wireless communication between electronic devices in accordance with a communication protocol, such as a communication protocol that is compatible with an IEEE 802.11 standard (which is sometimes referred to as Wi-Fi). However, the communication techniques can also be used with a wide variety of other communication protocols, and in electronic devices (such as portable electronic devices or mobile devices) that can incorporate multiple different radio access technologies (RATs) to provide connections through different wireless networks that offer different services and/or capabilities.

The electronic device and/or the second electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device and/or the second electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device and/or the second electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, IEEE 802.11me, IEEE 802.11bn, IEEE 802.11bx, IEEE 802.11mf or other present or future developed IEEE 802.11 technologies.

Note that the electronic device and/or the second electronic device can use multi-user transmission (such as OFDMA) and/or multiple-input multiple-output (MIMO).

In some embodiments, the electronic device and/or the second electronic device can act as a communications hub that provides access to a WLAN and/or to a WWAN and, thus, to a wide variety of services that can be supported by various applications executing on the electronic device and/or the second electronic device. Thus, the electronic device and/or the second electronic device can include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point can be a physical access point or a virtual or ‘software’ access point that is implemented on a computer or an electronic device. However, in other embodiments the electronic device and/or the second electronic device may not be an access point.

Additionally, it should be understood that the electronic devices described herein can be configured as multi-mode wireless communication devices that are also capable of communicating via different 3G and/or 2G RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein can be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) can be used herein to describe one or more consumer electronic devices that can be capable of performing procedures associated with various embodiments of the disclosure.

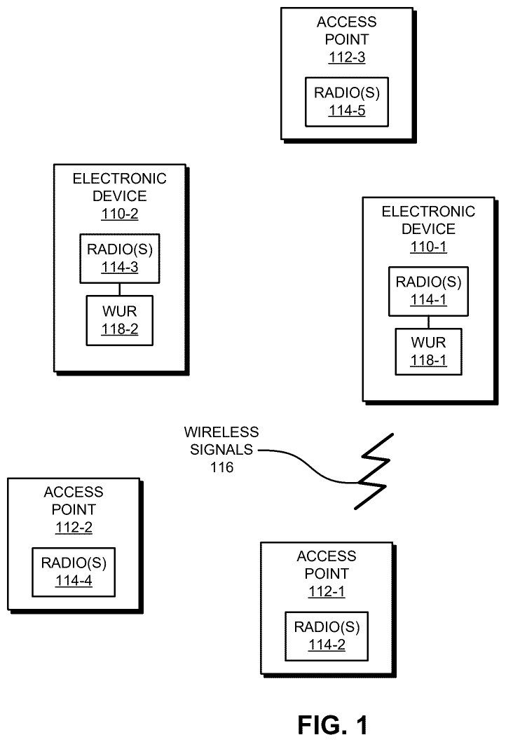

FIG. 1 presents a block diagram illustrating an example of electronic devices communicating wirelessly. Notably, one or more electronic devices 110 (such as a smartphone, a laptop computer, a notebook computer, a tablet, or another such electronic device) and access point 112-1 can communicate wirelessly in a WLAN using an IEEE 802.11 communication protocol. Thus, electronic devices 110 can be associated with or can have one or more connections with access point 112-1. For example, electronic devices 110 and access point 112-1 can wirelessly communicate while: detecting one another by scanning wireless channels, transmitting and receiving beacons or (equivalently) beacon frames on wireless channels, establishing connections (for example, by transmitting connect requests), and/or transmitting and receiving packets or frames (which can include the request and/or additional information, such as data, as payloads). Note that access point 112-1 can provide access to a network, such as the Internet, via an Ethernet protocol, and can be a physical access point or a virtual or ‘software’ access point that is implemented on a computer or an electronic device. In the discussion that follows, electronic devices 110 are sometimes referred to as ‘clients,’ ‘stations,’ or ‘recipient electronic devices.’

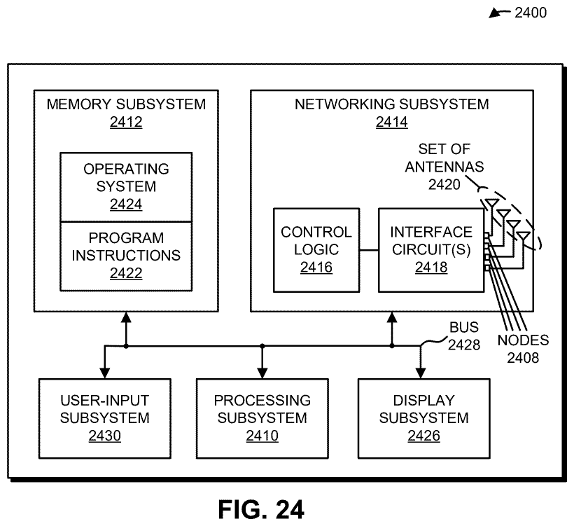

As described further below with reference to FIG. 24, electronic devices 110 and access point 112-1 can include subsystems, such as a networking subsystem, a memory subsystem, and a processor subsystem. In addition, electronic devices 110 and access point 112-1 can include radios 114 in the networking subsystems. More generally, electronic devices 110 and access point 112-1 can include (or can be included within) any electronic devices with networking subsystems that enable electronic devices 110 and access point 112-1, respectively, to wirelessly communicate with another electronic device. This can include transmitting beacon frames on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

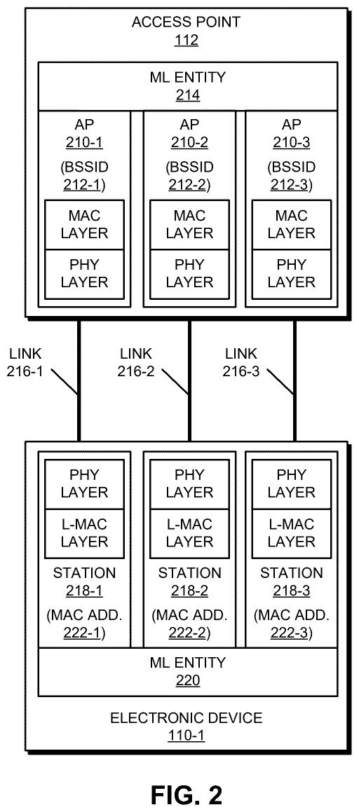

As can be seen in FIG. 1, wireless signals 116 (represented by a jagged line) are communicated by one or more radios 114-1 and 114-2 in electronic device 110-1 and access point 112-1, respectively. For example, as noted previously, electronic device 110-1 and access point 112-1 can exchange packets or frames using a Wi-Fi communication protocol in a WLAN. As illustrated further below with reference to FIGS. 2-23, one or more radios 114-1 can receive wireless signals 116 that are transmitted by one or more radios 114-2 via one or more links between electronic device 110-1 and access point 112-1. Alternatively, the one or more radios 114-1 can transmit wireless signals 116 that are received by the one or more radios 114-2.

In some embodiments, wireless signals 116 are communicated by one or more radios 114 in electronic devices 110 and access point 112-1, respectively. For example, one or more radios 114-1 and 114-3 can receive wireless signals 116 that are transmitted by one or more radios 114-2 via one or more links between electronic devices 110-1 and 110-2, and access point 112-1.

Note that the one or more radios 114-1 can consume additional power in a higher-power mode. If the one or more radios 114-1 remain in the higher-power mode even when they are not transmitting or receiving packets or frames, the power consumption of electronic device 110-1 can be needlessly increased. Consequently, electronic devices 110 can include wake-up radios (WURs) 118 that listen for and/or receive wake-up frames (and/or other wake-up communications), e.g., from access point 112-1. When a particular electronic device (such as electronic device 110-1) receives a wake-up frame, WUR 118-1 can selectively wake-up radio 114-1, e.g., by providing a wake-up signal that selectively transitions at least one of the one or more radios 114-1 from a lower-power mode to the higher-power mode.

IEEE 802.11be has proposed the use of multiple concurrent links between electronic devices, such as access point 112-1 and one or more of electronic device 110. For example, as shown in FIG. 2, which presents a block diagram illustrating an example of electronic devices communicating wirelessly, access point 112-1 can be an access point multi-link device (MLD) that includes multiple access points 210, which are cohosted or collocated in access point 112-1. In the present discussion, ‘cohosted’ or ‘collocated’ means that access points 210 are physically or virtually implemented in the same access point MLD, or are affiliated with the same access point MLD. Note that this meaning of ‘cohosted’ does not indicate that access points 210 have the same primary 20 MHz channel. Access points 210 can have associated BSSIDs 212, and media access control (MAC) and physical (PHY) layers (including separate radios, which can be included in the same or different integrated circuits). Note that access point 112-1 can have an ML entity 214 having an MLD MAC address, an ML identifier, a service set identifier (SSID), and that can provide security for access points 210.

Moreover, access points 210 can have different concurrent links 216 in different bands of frequencies (such as a link 216-1 with a link identifier 1 in a 2.4 GHz band of frequencies, a link 216-2 with a link identifier 2 in a 5 GHz band of frequencies and a link 216-3 with a link identifier 3 in a 6 GHz bands of frequencies) with stations 218 in at least electronic device 110-1, which is a non-access point MLD. These stations can have associated lower MAC and PHY layers (including separate radios, which can be included in the same or different integrated circuits). In addition, electronic device 110-1 can have an ML entity 220 having an MLD MAC address.

For example, the access point MLD can have three radios. One radio can operate on a 2.4 GHz band of frequencies, and the other radios can operate on the 5/6 GHz bands of frequencies. The access point MLD can create three access points 210, operating on a 2.4 GHz channel, a 5 GHz channel, and a 6 GHz channel respectively. The three access points 210 can operate independently, each of which has at least one BSS with different BSSIDs 212. (While FIG. 2 illustrates the access point MLD with three access points 210, more generally the access point MLD can include up to 15 access points with one or more access points in a given band of frequencies.) Moreover, each of the access points 210 can accommodate both legacy non-access point stations as well as non-access point MLD stations 218. Furthermore, each of access points 210 can transmit its own beacon frames using its own BSSID. Additionally, the access point MLD can have ML entity 214, identified by an MLD address (such as an MLD MAC address). This MAC address can be used to pair with ML entity 220 of the associated non-access point MLD stations 218.

Moreover, the non-access point MLD station (e.g., electronic device 110-1) can have two or three radios. One radio can operate on a 2.4 GHz band of frequencies, and the other radios can operate on the 5/6 GHz bands of frequencies. When the non-access point MLD establishes an ML association with the access point MLD, it can create up to three stations 218, each of which associates to one of access points 210 within the access point MLD. Each of stations 218 can have a different OTA MAC address 222. The non-access point MLD can also have ML entity 220, identified by another MLD address (such as another MLD MAC address). This MLD MAC address can be used to pair with ML entity 214 of the associated access point MLD.

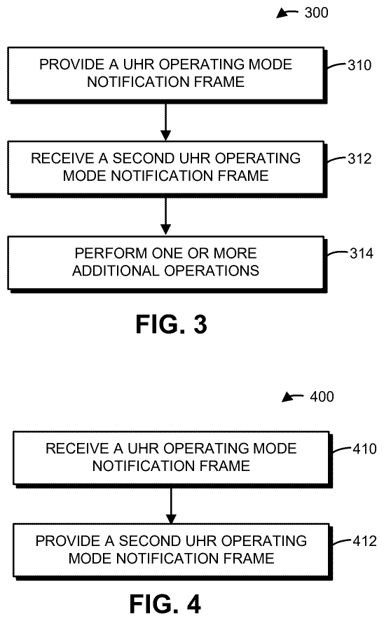

Referring back to FIG. 1, as noted previously, configuration of a DSO mode can be complicated and time-consuming, and can increase overhead in a network. In order to address these problems, as described further below with reference to FIGS. 3-24, in the communication techniques access point 112-1 and/or electronic device 110-1 can perform the communication techniques.

Notably, electronic device 110-1 can provide or generate, addressed to at least access point 112-1, a UHR operating mode notification frame. This UHR operating mode notification frame can include: an indication that a DSO mode is enabled; a second indication of whether a DSO parameter is present in the UHR operating mode notification frame; and a third indication of whether a DSO channel allocation is present in the UHR operating mode notification frame. The UHR operating mode notification frame 512 can be received by access point 112-1. Then, access point 112-1 can provide or generate, addressed to at least electronic device 110-1, a second UHR operating mode notification frame as a response to the UHR operating mode notification frame that confirms the DSO mode. The second UHR operating mode notification frame can be received by electronic device 112-1.

Alternatively, electronic device 110-1 can provide or generate, addressed to at least access point 112-1, a BSRP or an MU-RTS message that includes a DSO ICF, where the DSO ICF indicates initiation of a DSO TXOP. This BSRP or MU-RTS message can be received by access point 112-1.

Then, access point 112-1 can provide or generate, addressed to at least electronic device 110-1 and on a DSO channel, at least one of a BSR in response to the BSRP message or a CTS frame in response to the MU-RTS message. The BSR can have a trigger-based PPDU format or the CTS frame can have a non-high throughput duplicate transmission format. Note that the BSR or the CTS frame can be received by the one or more electronic device 110-1.

In summary, the disclosed communication techniques can facilitate configuration and, thus, use of a DSO mode. For example, the communication techniques can facilitate the use of bandwidth puncturing and/or beamforming in the DSO mode. In these ways, the communication techniques can improve the user experience when using electronic device 110-1 and/or access point 112-1.

While the preceding discussion illustrated communication by electronic device 110-1 to access point 112-1, in other embodiments the roles of access point 112-1 and electronic device 110-1 can be reversed in the communication techniques. For example, electronic device 110-1 can include a second access point and access point 112-1 can be a second electronic device which is a station or client that is associated with the second access point. Alternatively, in some embodiments, the communication techniques are performed between electronic device 110-1 and electronic device 110-2.

Note that access point 112-1 and one or more electronic devices (such as electronic devices 110-1 and/or 110-2) can be compatible with an IEEE 802.11 standard that includes trigger-based channel access (such as IEEE 802.11ax). However, access point 112-1 and the one or more electronic devices can also communicate with one or more legacy electronic devices that are not compatible with the IEEE 802.11 standard (i.e., that do not use multi-user trigger-based channel access). In some embodiments, access point 112-1 and the one or more electronic devices use multi-user transmission (such as OFDMA). For example, the one or more radios 114-2 can provide one or more trigger frames for the one or more electronic devices. Moreover, in response to receiving the one or more trigger frames, the one or more radios 114-1 can provide one or more group or block acknowledgments to the one or more radios 114-2. For example, the one or more radios 114-1 can provide the one or more group acknowledgments during associated assigned time slot(s) and/or in an assigned channel(s) in the one or more group acknowledgments. However, in some embodiments one or more of electronic devices 110 can individually provide acknowledgments to the one or more radios 114-2. Thus, the one or more radios 114-1 (and, more generally, radios 114 in the electronic devices 110-1 and/or 110-2) can provide one or more acknowledgments to the one or more radios 114-2.

In the described embodiments, processing a packet or frame in one of electronic devices 110 and access point 112-1 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication techniques can be characterized by a variety of communication-performance metrics. For example, the communication-performance metric can include one or more of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a predetermined or predefined time interval (such as a time interval between, e.g., 1 and 10 s) to an estimated maximum number of bytes that can be communicated in the predetermined or predefined time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices can be present. For example, some embodiments can include more or fewer electronic devices. As another example, in other embodiments, different electronic devices can be transmitting and/or receiving packets or frames. In some embodiments, multiple links can be used during communication between electronic devices 110. Consequently, one of electronic devices 110 can perform operations in the communication techniques.

FIG. 3 presents a flow diagram illustrating an example method 300 for providing a UHR operating mode notification frame. This method can be performed by an electronic device, such as electronic device 110-1 in FIG. 1. For example, method 300 can be implemented by an interface circuit in electronic device 110-1 in FIG. 1, which can be a station or client that is associated with access point 112-1. Note that the communication between the electronic device and a second electronic device (such as access point 112-1 in FIG. 1) can be compatible with an IEEE 802.11 communication protocol.

During operation, the electronic device can provide, addressed to a second electronic device, a UHR operating mode notification frame (operation 310). This UHR operating mode notification frame can include: an indication that a DSO mode is enabled; a second indication of whether a DSO parameter is present in the UHR operating mode notification frame; and a third indication of whether a DSO channel allocation is present in the UHR operating mode notification frame. Then, the electronic device can receive, associated with the second electronic device, a second UHR operating mode notification frame (operation 312) as a response to the UHR operating mode notification frame that confirms the DSO mode.

Note that the UHR operating mode notification frame can include an action frame.

Moreover, the electronic device can include a non-access point station. Note that the DSO parameter can include at least one of: a DSO padding; a DSO transition delay corresponding to a switching time of the second electronic device to a DSO channel; or a number of DSO channels having a bandwidth of 80 MHz in a bandwidth of 320 MHz. In some embodiments, the DSO channel allocation can include a DSO channel location having a bandwidth of 80 MHz. This DSO channel location can be indicated with a bitmap.

Furthermore, when a basic service set bandwidth equals 160 MHz or a number of DSO channels having a bandwidth of 80 MHz equals 3 in a basic service set bandwidth of 320 MHz, the UHR operating mode notification frame can enable the DSO mode without a subsequent response.

Additionally, when a basic service set bandwidth is 320 MHz and a DSO channel bandwidth is 80 MHz, the electronic device can support one DSO channel.

In some embodiments, the UHR operating mode notification frame can specify a DSO channel location having a bandwidth of 80 MHz.

Note that the UHR operating mode notification frame can enable the DSO mode for multiple links.

In some embodiments, the electronic device can optionally perform one or more additional operations (operation 314). For example, prior to providing the UHR operating mode notification frame (operation 310), the electronic device can receive, associated with the second electronic device, a probe response, an association response or a re-association response. The probe response, the association response or the re-association response can include a UHR operating element. Moreover, the UHR operating element can include: a DSO transition timeout, and a DSO 80 MHz subband assignment. Note that, after the DSO transition timeout has elapsed, the DSO mode can be enabled.

Moreover, the electronic device can receive, associated with the second electronic device, a second UHR operating mode notification frame as a response to the UHR operating mode notification frame, where the DSO mode is enabled based at least in part on the second UHR operating mode notification frame. The second UHR operating mode notification frame can specify a DSO 80 MHz subband assignment.

Furthermore, when the second electronic device stops a transmit opportunity, the electronic device can return to a primary channel having a bandwidth of 80 MHz or 160 MHz and can experience a blindness having a predefined duration.

Additionally, the electronic device can puncture one or more channels having a 20 MHz bandwidth and the DSO mode does not use the one or more punctured channels.

In some embodiments, the electronic device can provide, addressed to the second electronic device, an ICF that indicates a CCA criterion.

Note that at the end of a TXOP, the electronic device can provide, addressed to the second electronic device, a trigger frame having a duration of 0 and padding corresponding to a DSO transition delay.

Moreover, at the end of a TXOP, the electronic device can provide, addressed to the second electronic device, a PPDU having a NAV value of at least a summation of a PIFS, 20 μs and a DSO transition delay.

Furthermore, the electronic device can perform beamforming in the DSO mode.

Additionally, the electronic device can assign a resource unit in the DSO mode for group address frame delivery.

In some embodiments, the electronic device can provide, addressed to the second electronic device, a management or an action frame that enables one or more of: an EMLSR mode, a DUO mode, or a DPS mode. The DSO mode can operate concurrently with one or more of: the EMLSR mode, the DUO mode or the DPS mode. Note that the management of the action frame can include padding and/or a switching delay, and a transition delay and/or switch back delay to enable one or more of: the EMLSR mode, the DPS mode or the DSO mode. In some embodiments, the electronic device can: receive, associated with the second electronic device, a BSRP that initiates a TXOP; and provide, addressed to the second electronic device, an M-BA.

FIG. 4 presents a flow diagram illustrating an example method 400 for receiving a UHR operating mode notification frame. This method can be performed by a second electronic device, such as access point 112-1 in FIG. 1. For example, method 300 can be implemented by an interface circuit in access point 112-1 in FIG. 1. Note that the communication between the second electronic device and an electronic device (such as electronic device 110-1 in FIG. 1, which can be a station or client that is associated with access point 112-1) can be compatible with an IEEE 802.11 communication protocol.

During operation, the second electronic device can receive, associated with an electronic device, a UHR operating mode notification frame (operation 410). This UHR operating mode notification frame can include: an indication that a DSO mode is enabled; a second indication of whether a DSO parameter is present in the UHR operating mode notification frame; and a third indication of whether a DSO channel allocation is present in the UHR operating mode notification frame. Then, the second electronic device can provide, addressed to the electronic device, a second UHR operating mode notification frame (operation 412) as a response to the UHR operating mode notification frame that confirms the DSO mode.

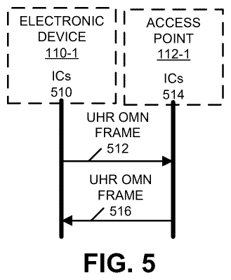

The communication techniques are further illustrated in FIG. 5, which presents a flow diagram illustrating an example of communication between electronic device 110-1 and access point 112-1. During operation, one or more interface circuits (or interface circuitry) 510 in electronic device 110-1 can provide, addressed to at least access point 112-1, a UHR operating mode notification (OMN) frame 512. This UHR operating mode notification frame can include: an indication that a DSO mode is enabled; a second indication of whether a DSO parameter is present in the UHR operating mode notification frame; and a third indication of whether a DSO channel allocation is present in the UHR operating mode notification frame. The UHR operating mode notification frame 512 can be received by one or more interface circuits (or interface circuitry) 514 in access point 112-1.

Then, the one or more interface circuit 514 can provide, addressed to at least electronic device 110-1, a UHR operating mode notification frame 516 as a response to the UHR operating mode notification frame 512 that confirms the DSO mode. The UHR operating mode notification frame 516 can be received by the one or more interface circuits 510.

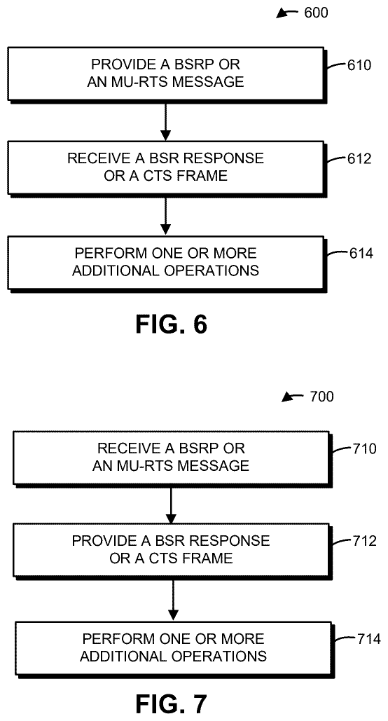

FIG. 6 presents a flow diagram illustrating an example method 600 for providing a BSRP or an MU-RTS message. This method can be performed by an electronic device, such as electronic device 110-1 in FIG. 1. For example, method 300 can be implemented by an interface circuit in electronic device 110-1 in FIG. 1, which can be a station or client that is associated with access point 112-1. Note that the communication between the electronic device and a second electronic device (such as access point 112-1 in FIG. 1) can be compatible with an IEEE 802.11 communication protocol.

During operation, the electronic device can provide, addressed to a second electronic device, the BSRP or the MU-RTS message (operation 610) that includes a DSO ICF, where the DSO ICF indicates initiation of a DSO TXOP. Then, the electronic device can receive, associated with the second electronic device and on a DSO channel, at least one of a BSR in response to the BSRP or a CTS frame in response to the MU-RTS (operation 612). The BSR can have a trigger-based PPDU format or the CTS frame can have a non-high throughput duplicate transmission format.

In some embodiments, the electronic device can optionally perform one or more additional operations (operation 614). For example, the electronic device can puncture one or more channels having a bandwidth of 20 MHz and the DSO mode does not use the one or more punctured channels. The puncturing can be specified in the DSO ICF, a trigger frame, or an OFDMA preamble.

Moreover, the electronic device can perform beamforming in the DSO mode.

Furthermore, the electronic device can assign a resource unit in the DSO mode for group address frame delivery.

FIG. 7 presents a flow diagram illustrating an example method 700 for receiving a BSRP or an MU-RTS message. This method can be performed by a second electronic device, such as access point 112-1 in FIG. 1. For example, method 300 can be implemented by an interface circuit in access point 112-1 in FIG. 1. Note that the communication between the second electronic device and an electronic device (such as electronic device 110-1 in FIG. 1, which can be a station or client that is associated with access point 112-1) can be compatible with an IEEE 802.11 communication protocol.

During operation, the second electronic device can receive, associated with an electronic device, the BSRP or the MU-RTS message (operation 710) that includes a DSO ICF, where the DSO ICF indicates initiation of a DSO TXOP. Then, the second electronic device can provide, addressed to the electronic device and on a DSO channel, at least one of a BSR in response to the BSRP or a CTS frame in response to the MU-RTS (operation 712). The BSR can have a trigger-based PPDU format or the CTS frame can have a non-high throughput duplicate transmission format.

In some embodiments, the second electronic device can optionally perform one or more additional operations (operation 714). For example, when the MU-RTS represents the DSO ICF, the second electronic device can change a resource-unit allocation to allow the CTS frame to be communicated on the DSO channel. Moreover, when the electronic device stops a transmit opportunity, the second electronic device can return to a primary channel having a bandwidth of 80 MHz or 160 MHz and can experience a blindness having a predefined duration. Furthermore, the second electronic device can receive, from the electronic device, information specifying one or more channels having a bandwidth of 20 MHz that are punctured, where, in the DSO mode, the second electronic device does not use the one or more channels in the DSO mode. Note that the information can be specified in the DSO ICF, a trigger frame, or an OFDMA preamble.

In some embodiments of methods 300 (FIG. 3), 400 (FIG. 4), 600 (FIG. 6) and/or 700, there can be additional or fewer operations. Further, one or more different operations can be included. Moreover, the order of the operations can be changed, and/or two or more operations can be combined into a single operation or performed at least partially in parallel.

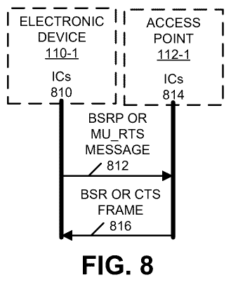

The communication techniques are further illustrated in FIG. 8, which presents a flow diagram illustrating an example of communication between electronic device 110-1 and access point 112-1. During operation, one or more interface circuits (or interface circuitry) 810 in electronic device 110-1 can provide, addressed to at least access point 112-1, a BSRP or an MU-RTS message 812 that includes a DSO ICF, where the DSO ICF indicates initiation of a DSO TXOP. This BSRP or MU-RTS message can be received by one or more interface circuits (or interface circuitry) 814 in access point 112-1.

Then, the one or more interface circuit 814 can provide, addressed to at least electronic device 110-1 and on a DSO channel, at least one of a BSR 816 in response to the BSRP message or a CTS frame 818 in response to the MU-RTS message. BSR 816 can have a trigger-based PPDU format or CTS frame 818 can have a non-high throughput duplicate transmission format. BSR 816 or CTS frame 818 can be received by the one or more interface circuits 810.

While communication between the components in FIGS. 5 and 8 are illustrated with unilateral or bilateral communication (e.g., lines having a single arrow or dual arrows), in general a given communication operation can be unilateral or bilateral. Moreover, while operations in FIGS. 5 and 8 are illustrated as being sequential, in some embodiments at least some of the operations can be performed in parallel.

We now further describe embodiments of the disclosed communication techniques. As discussed previously, configuration of a DSO mode can be time-consuming and complicated, and can increase the overhead in a network. These challenges can be addressed using the disclosed communication techniques.

Notably, in the disclosed communication techniques, details and rules for a station and an access point to support DSO feature are described, including: signaling to enable/disable the DSO feature; frame exchange in the DSO; puncturing in the DSO operation; and beamforming in the DSO operation.

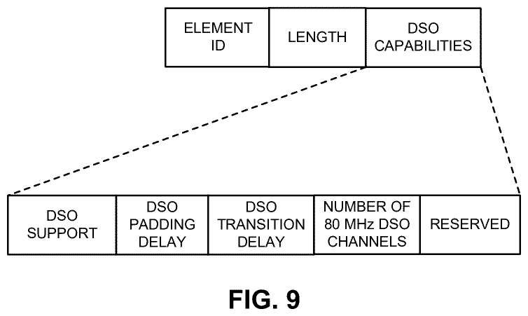

Moreover, a new element can be used in DSO signaling, e.g., during association. This is shown in FIG. 9, which presents a drawing illustrating an example of a DSO operating mode notification element. Notably, the DSO operating mode notification element can include: an element identifier (e.g., using one octet); a length (e.g., using one octet); and DSO capabilities (e.g., using two octets). In particular, a DSO station may need time to switch between a primary channel and one or more DSO channels, so it can indicate these parameters, such as: a DSO padding delay (e.g., using five bits), which is the time needed for a DSO station to switch from the primary channel to a DSO channel; a DSO transition delay (e.g., using five bits), which is the time needed for a DSO station to switch from a DSO channel to the primary channel; and/or an optional delay field (e.g., with 5 bits, a delay value in a range of 0 to 256 μs can be achieved with 8 μs resolution). Note that a DSO station can indicate a number of 80 MHz DSO channels for a 320 MHz bandwidth in 6 GHz that it can support for DSO operation. It can be optional for a station to indicate the number of 80 MHz DSO channels (e.g., using two bits). Furthermore, during association, a DSO station can indicate these parameters in a DSO operating mode notification element (e.g., using two octets). This element can be carried in a per-station profile of the link Information field of the basic multi-link element in an association request or a probe request. In the DSO capabilities, note that: the DSO support can be indicated using, e.g., one bit; the DSO padding delay can be indicated using, e.g., five bits; the DSO transition delay can be indicated using, e.g., five bits; and/or the number of 80 MHz DSO channels can be indicated using, e.g., two bits. In some embodiments, there may be a reserved subfield, e.g., with three bits.

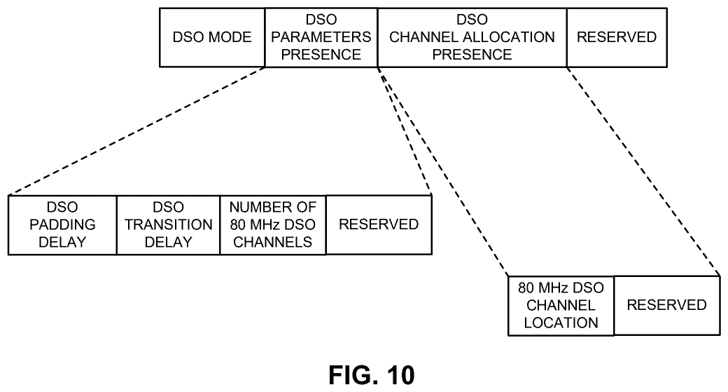

As shown in FIG. 10, which presents a drawing illustrating an example of a DSO operating mode notification element, a DSO station can enable/disable the DSO mode using a DSO operating mode notification frame. The DSO operating mode notification frame is an action frame that can be sent by a DSO station and/or an access point. Note that the DSO operating mode notification frame can include: a category; a protected UHR action; a dialog token; a DSO control; optional DSO parameters; and/or optional DSO channel allocation.

In the DSO operating mode notification frame, there can be: a DSO mode; an optional DSO parameters presence; an optional DSO channel allocation presence; and a reserved subfield. The DSO mode (e.g., one bit) can, e.g., be set to ‘0’ to disable and set to ‘1’ to enable the DSO mode. Moreover, the optional DSO parameters presence bit can, e.g., be set to ‘1’ by a non-access point station to indicate the availability of DSO parameters. Furthermore, the optional DSO channel allocation presence bit can, e.g., be set to ‘1’ by an access point to indicate the availability of DSO channel allocation. Note that the reserved subfield can include, e.g., six bits.

The DSO parameters field can include: DSO padding delay (e.g., five bits) and DSO transition delay (e.g., five bits) to indicate the switching time of the DSO station; and/or a number of 80 MHz DSO channels (e.g., two bits) is to indicate the number of DSO channels on a 320 MHz bandwidth. Note that a reserved subfield can include, e.g., four bits.

Moreover, a DSO channel allocation field can include an 80 MHz DSO channel location to indicate the location of 80 MHz DSO channels using, e.g., a four-bit bitmap for DSO operation. A reserved subfield can include, e.g., four bits.

Note that a station can send the DSO operating mode notification frame as a request by, e.g., setting the DSO mode to ‘1’ and setting the DSO parameters subfield accordingly to enable the DSO. Moreover, after receiving the request, an access point can send a DSO operating mode notification frame as a response with, e.g., DSO mode set to the same value received from the STA in the request frame and allocating the DSO channels, if needed, by setting the 80 MHz DSO channel allocation subfield. Then, when the station responds to confirm, the DOS mode can be enabled.

However, when the basic service set (BSS) bandwidth is 160 MHz or when a station sets the “number of 80 MHz DSO channels” to, e.g., ‘3’ in a 320 MHz basic service set bandwidth, an access point may not send the DSO operating mode notification frame as the response and only the request from station can be sufficient for enabling the DSO mode. In some embodiments, a timeout can be defined for enabling the DSO mode instead of an access point sending the DSO operating mode notification frame as the response to the station. Consequently, after a timeout duration from the end of an acknowledgment (ACK) to the station (or an ACK to the DSO operating mode notification request frame), the DSO mode can be enabled.

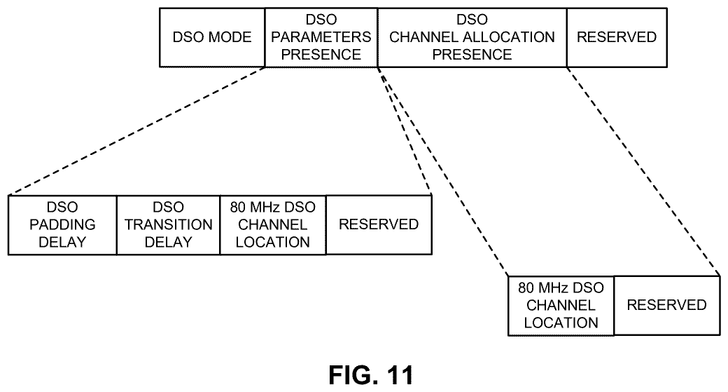

Furthermore, as shown in FIG. 11, which presents a drawing illustrating an example of a DSO operating mode notification element, when the basic service set bandwidth is 320 MHz and the bandwidth of a DSO station is 80 MHz, a station may not be able to support all the three additional 80 MHz channels. In such a case the station can only support one DSO channel. Such stations can request this DSO channel by transmitting a DSO operating mode notification frame with the 80 MHz DSO channel location that it wants to use as the DSO channel.

After receiving the request, an access point can accept the request by sending the DSO operating mode notification frame as a response by setting the DSO channel allocation presence subfield to, e.g., ‘1’ and setting the 80 MHz DSO channel location subfield to the same value in the DSO operating mode notification request frame from the station. Alternatively, the access point can propose an alternative DSO channel location by sending the DSO operating mode notification frame as a response by setting the DSO channel allocation presence subfield to, e.g., ‘1’ and setting the 80 MHz DSO channel Location subfield to a different value than was in the DSO operating mode notification request frame from the station. Note that, when the alternative DSO channel location proposed by the access point is not acceptable to the STA, then the station can send another DSO operating mode notification frame to request another alternative value.

In FIG. 11, note that, in the DSO parameters field, the number of 80 MHz DSO channels can be replaced with the 80 MHz DSO channel location.

The frame exchange in the DSO setup can include the ICF and an initial control response (ICR). A BSRP and/or an MU-RTS can be used as the ICF, so that an EMLSR station and a DSO station can be scheduled in a TXOP. (While IEEE 802.11be allows stations to simultaneously operate on multiple links using multiple radios in a higher-power mode, this can be expensive in terms of power consumption. Instead, a station can have one or more radios in an EMLSR mode. This can allow lower-power listening (or monitoring) until a radio in a higher-power mode is needed on a given link.)

When BSRP is used as a DSO ICF, a BSR in trigger-based (TB) PPDU format can be sent as the response. Note that, in response to the BSRP, the one or more other parameters can be included, such as: Wi-Fi coexistence (coex) feedback information (such as a dynamic unavailability operation or DUO), DPS, etc.

Alternatively, when an MU-RTS is used as a DSO ICF, a CTS in non-high throughput (HT) duplicate (dup) transmission can be sent as the response. When DSO station(s) receive an MU-RTS, they can switch to a DSO channel and can send a CTS response on the corresponding DSO channel to provide protection to the TXOP responder side. As discussed later, note that the resource unit (RU) allocation rules for MU-RTS can be changed to allow the CTS transmission on the DSO channels.

An access point may need to include sufficient padding in an ICF to meet the channel switching time of a DSO station from a primary channel to a DSO channel. The ICF may need to include the intermediate frame check sequence (FCS) or message integrity code (MIC) before the start of padding required by the DSO station(s). When all the stations that are scheduled in a TXOP support/enable the MIC protection, only the MIC inclusion is sufficient. However, when none of the stations support/enable MIC protection, then only the intermediate FCS is included. In some embodiments, when some of the stations that are scheduled in a TXOP do not support and/or enable MIC protection, both intermediate FCS and MIC can be included in the ICF.

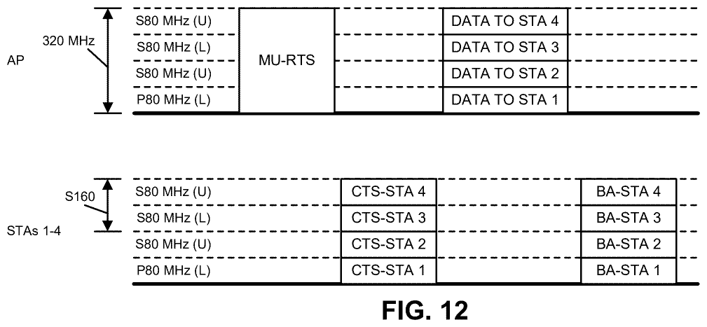

Additionally, as shown in FIG. 12, which presents a drawing illustrating an example of communication between the electronic devices of FIG. 1 or 2, in MU-RTS, the resource-unit allocation in the user-info field can be changed to allow the CTS to be sent on the DSO channel. For the primary channel, the access point can follow the resource-unit allocation rules for MU-RTS defined in IEEE 802.11be. Moreover, for DSO channels, the access point can follow the resource-unit allocation rules defined in ‘Table 9-53—B7-B1 of the RU Allocation subfield’ for other trigger frames with the exception that the only allowed resource-unit resolution is 80 MHz or 160 MHz.

In some embodiments, the allocated resource-unit size in a secondary channel can be 80 MHz or 160 MHz on DSO channels. For example, as shown in the figure, when station 3 and station 4 are 160 MHz DSO stations, an access point can schedule a lower 80 MHz of S160 to station 3 and an upper 80 MHz of S160 to station 4.

Alternatively, the allocated resource-unit size in the secondary channel can be the same as the DSO station operating bandwidth in MU-RTS. For example, if station 3 and station 4 are 160 MHz DSO stations, the access point can schedule a 160 MHz resource unit to these stations. Note that, even when the access point does not have the capability of parallel detection/decoding, the CTS response sent by the stations can provide TXOP protection. The disadvantage is that the access point cannot use the CTS responses on the DSO channel for better scheduling. In the example in the figure, when the access point uses 320 MHz bandwidth and schedules four 80 MHz stations, it can use the PS160 and B0 value to indicate the DSO channels and sets B7-B1 to, e.g., ‘67.’ Thus, in FIG. 12, the resource-unit allocation for station 1 can be PS160=‘0’ with B0=‘0’ and B7-B1=‘67’; the resource-unit allocation for station 2 can be PS160=‘0’ with B0=‘1’ and B7-B1=‘67’; the resource-unit allocation for station 3 can be PS160=‘1’ with B0=‘0’ and B7-B1=‘67’; and the resource-unit allocation for station 4 can be PS160=‘1’ with B0=‘1’ and B7-B1=‘67’.

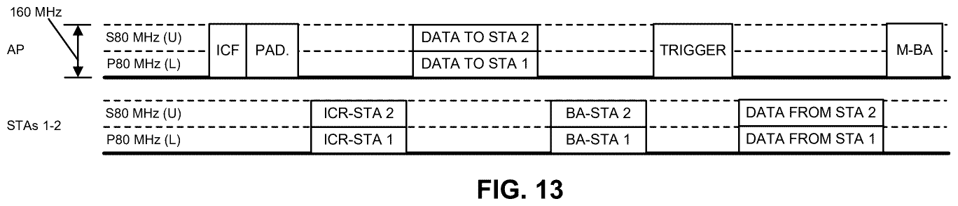

As shown in FIG. 13, which presents a drawing illustrating an example of communication between the electronic devices of FIG. 1 or 2, for the frame exchange in DSO for resource allocation, the access point can follow the rule for resource-unit allocation to the DSO station. The uplink (UL) bandwidth subfield (PS160) and the resource-unit allocation subfield (B0 and B7-B1) can indicate the size and location of the resource unit(s). Note that B0 and PS160 can indicate the secondary 80 MHz and 160 MHz channels. The access point can assign the resource-unit index in the DSO channel(s) with reference to the primary channel. When a DSO station switches to a DSO channel, it may need to map the resource-unit allocation in the trigger frames (e.g., any trigger frame during the TXOP) with reference to the primary channel to derive its allocated resource unit(s).

Thus, in FIG. 13, in the ICF and the trigger: the resource-unit allocation for station 1 can be specified with B0=‘0’ and B7-B1=‘67’; and the resource-unit allocation for station 2 can be specified with B0=‘1’ and B7-B1=‘67’. Furthermore, when data is provided from station 2, station 2 can operate on S80 and may need to map the RU allocation in the trigger frame to the primary 20 MHz of the access point.

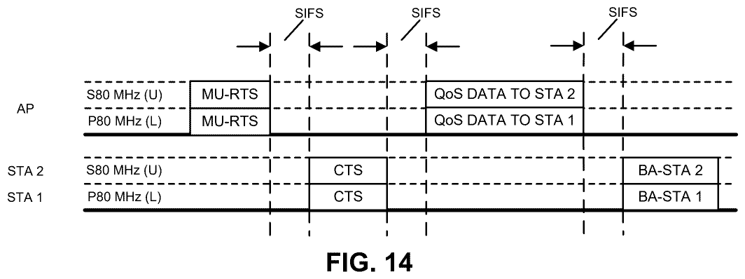

Moreover, as shown in FIG. 14, which presents a drawing illustrating an example of communication between the electronic devices of FIG. 1 or 2, in some embodiments of the frame exchange in the DSO, there can be a carrier sense (CS) before the ICR is transmitted. Notably, uplink multi-user CS rules can require stations to check an energy detection (ED) and virtual CS before responding to an MU-RTS. Furthermore, when switching to a secondary channel, a DSO station usually does not know the medium state of the secondary channel. In order to increase the reliability of the secondary channel usage, a station can be required to use a lower energy-detection threshold to provide better protection against overlapping basic service sets. For example, an access point can announce a medium synchronization delay energy-detection threshold that is in range of −62 to −72 dBm.

Currently, when a station responds to an MU-RTS, it can first check the NAV on P20 and check energy detection during the short inter-frame sequence (SIFS) on a secondary channel (e.g., S20 equal to −62 dBm, S40, S80). Options for responding to the CTS on S80 can include: checking the NAV on P20 and check the energy detection on the secondary channel during the SIFS (e.g., −62 dBm); or NAV is not checked on P20 and only the energy-detection check (e.g., with an medium-synchronization-delay energy-detection threshold between −62 to −72 dBm) is performed after switching on the secondary channel during SIFS. Thus, in FIG. 14, station 2 can perform energy detection on S80 with a threshold of −72 dBm during the first SIFS. Moreover, in FIG. 14, note that station 1 can be an 80 MHz only station, and station 2 can be an 80 MHz only DSO station.

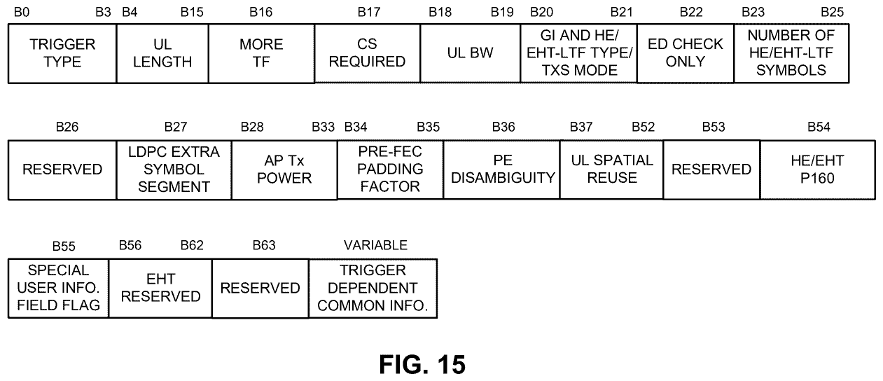

As shown in FIG. 15, which presents a drawing illustrating an example of an action frame during communication between the electronic devices of FIG. 1 or 2, there can be a variety of ways for an access point to indicate the CS check behavior to a station using an ICF. In a first option, a new subfield can be defined. This approach can provide three clear channel assessment (CCA) check levels: no CCA check, NAV and ED check, and ED check only. For example, in the first option, using a reserved bit, e.g. B22, in an extremely high throughput variant common information field format can be repurposed to signal ‘ED check only.’ Moreover, when a CS required subfield is set to ‘1,’ an access point can use the ‘ED check only’ bit as an indication of ignoring the NAV on primary channel and only checking ED after switching to the DSO channel.

Alternatively, in a second option, the CS required subfield can be reused. Notably, when an access point sets the CS required subfield to ‘1,’ a DSO station can ignore the NAV on the primary channel and may only check ED on the DSO channel. However, the access point may not have a control to force a station to check NAV and ED.

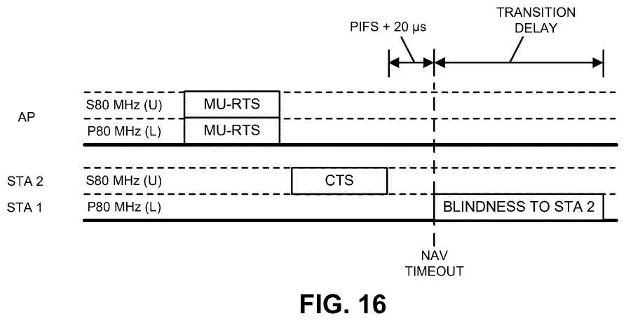

Moreover, as shown in FIGS. 16-18, which present drawings illustrating examples of communication between the electronic devices of FIG. 1 or 2, for the end-of-frame exchange in DSO, blindness can occur, which can necessitate medium synchronization recovery. Several approaches can be used. In a first case or embodiment, when an access point stops a TXOP after no CTS response is received on the primary channel, the DSO station can switch back to P80 and can experience blindness for a duration equal to a transition delay. However, when there is a hidden node problem from responder, the blindness duration can be longer. Alternatively, in a second case or embodiment, when a first station does not send a block acknowledgment response (e.g., because it could not receive downlink or DL data) and then the access point stops the TXOP, the DSO station can returns to P80 and can experience blindness for a duration equal to a PIFS plus a receive start indication (RxStartIndication), e.g., 20 μs, plus a transition delay. In a third case or embodiment, when the access point stops the TXOP, a DSO station can return to P80 and can experience a blindness duration equal to PIFS plus 20 μs plus the transition delay.

As shown in FIG. 16, which presents embodiments of a switch back mechanism for DSO stations, in this first option a DSO station can follow the EMLSR switch back mechanism in IEEE 802.11be to determine the end of a TXOP and to switch from the DSO channel to the primary channel. The blindness duration of a station can be the PIFS plus 20 μs plus the DSO transition delay.

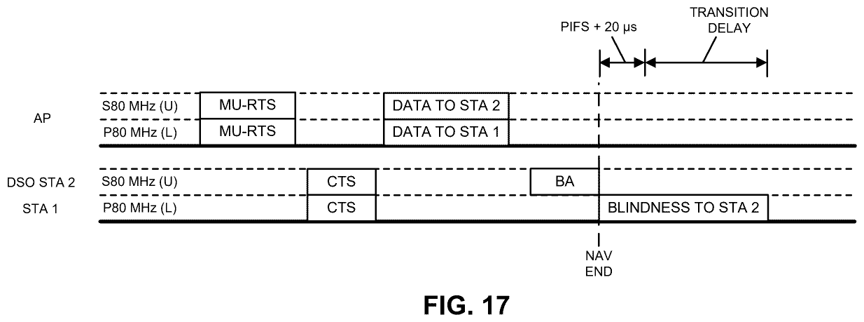

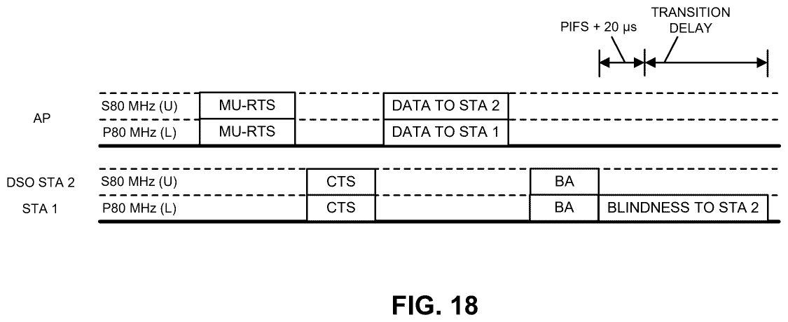

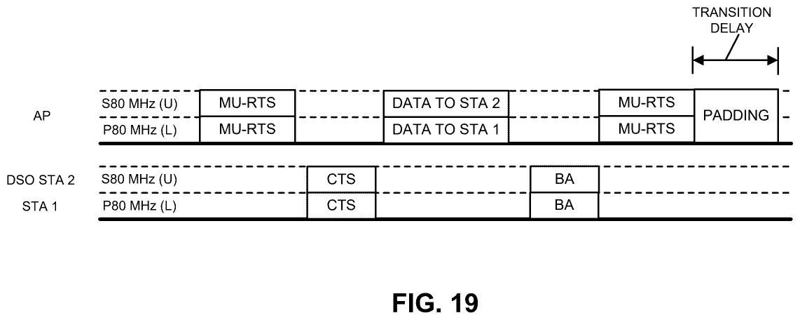

Alternatively, FIGS. 17 and 18 presents a second option and a third option that can be used to eliminate the need for medium synchronization recovery. In the second option, which is further illustrated in FIG. 19, which presents a drawing illustrating an example of communication between the electronic devices of FIG. 1 or 2, in addition to following the rules in the first option, in order to eliminate the blindness issue, an access point can send a trigger frame (such as a MU-RTS) with duration field set to ‘0’ with sufficient padding for the DSO transition delay. A DSO station can start a switch back to the primary channel after receiving a trigger frame. The trigger frame can have explicit signaling for the end of a TXOP or a dummy user information field can be included which does not match the association identifier of the station. However, in this approach, an access point cannot also transmit to other stations during this time.

In the third option shown in FIG. 18, in addition to following the rules in the first option, an access point can set a NAV duration in the last PPDU sent to a value that reserves the medium for the PIFS plus 20 μs plus a DSO transition delay duration that is longer than the end of the TXOP. This can reserve the medium so that other stations will not transmit. Consequently, only the access point can access the channel during the switch back of the DSO station. Note that, when the DSO frame exchange is finished, both the access point and the station may not initiate a TXOP with each other until the PIFS plus a receiver physical start delay plus a transition delay duration from the end of the TXOP has elapsed.

Furthermore, a subchannel can be punctured in the DSO. For example, an access point can use the ‘disabled subchannel bitmap’ subfield in extremely high throughput operation or a bandwidth indication element to puncture one or more of the subchannels. When one of the DSO channels are completely punctured, the access point may not allocate that DSO channel for DSO operation. Furthermore, stations that are switching to DSO channels outside of the primary channel can consider a puncturing pattern over the basic service set bandwidth announced by the access point when transmitting or receiving on the DSO channels. Similarly, a station may only need to prepare a channel quality indicator (CQI) report for the non-punctured subchannels of the DSO channel.

In some embodiments, dynamic subchannel puncturing can be used. For simplification of the DSO design and implementation of dynamic subchannels, an access point can puncture the initial control frame and/or trigger frame. Then, in the resource-unit allocation for OFDMA scheduling, those subchannels corresponding to 20 MHz may not be assigned to any stations in the same TXOP. Note that this puncturing can be in addition to the static puncturing in a ‘disabled subchannel bitmap; subfield in an extremely high throughput operation element.

An alternative embodiment can be used for OFDMA preamble puncturing. Notably, an access point can use OFDMA preamble puncturing to puncture some of the resource units using a current approach. For example, the access point can use an extremely high throughput multi-user PPDU or an extremely high throughput trigger-based PPDU to puncture some of the subchannels in baseline. The access point can use the universal signal (U-SIG) and extremely high throughput-signal (EHT-SIG) fields to indicate the preamble puncturing in an extremely high throughput multi-user PPDU.

When an access point wants to use OFDMA preamble puncturing in DSO, different embodiments can be used. For example, in some embodiments, when an access point uses a bandwidth query report poll (BQRP)/bandwidth query report (BQR) information to puncture some of the channels, then the station will not be using the channel(s) that it has indicated to the AP in the BQR as being punctured. Consequently, OFDMA preamble puncturing can work without anchor channel definition for DSO.

Alternatively, in some embodiments, when preamble puncturing is because a CCA is high at the access-point side, a station may not know which channel is punctured. Therefore, the station may need an anchor channel to be defined on the DSO channel(s). Otherwise, the station can decode the punctured 20 MHz channel and miss the preamble decoding. Consequently, the access point can avoid using the preamble puncturing.

By defining an anchor channel, an access point can use OFDMA preamble puncturing. The anchor channel can be the primary channel of the DSO channel. An access point can puncture any 20 MHz channel(s) of the DSO channel except the anchor channel. When the anchor channel is busy, then the access point may not allocate any resource units on that DSO channel.

Additionally, beamforming can be used in DSO. In order to achieve same performance on the DSO channel as the primary channel, an access point can perform single-user (SU) and multi-user beamforming on the DSO channels. However, in some embodiments, it can be challenging to achieve the full flexibility for performing the beamforming. For example, when the bandwidth of an access point is 320 MHz and the bandwidth of a DSO station is 80 MHz, the access point may need to send an ICF to separately initiate a TXOP with a DSO station four times in order to receive the CQI report over the primary channel and the DSO channels.

There can be several options for sounding. Notably, in a first option, the access point can sound a DSO-capable station on either primary channel or one of the DSO channel(s). Consequently, the access point can schedule the DSO station on that DSO channel until the next sounding. For example, the access point can perform sounding every 100 ms on a primary or a DSO channel for a DSO station. Before the next sounding update, the access point can allocate a resource unit to a DSO station based at least in part on previous sounding.

Moreover, in a second option, sounding can be performed every 100 ms for a primary channel and all DSO channels (depending on the capability of a station in supporting multiple DSO channels). However, the overhead for initiating a TXOP for each sounding on DSO channels to collect the CQI report can be an issue.

In a third option, sequential sounding can be used. This is discussed further below.

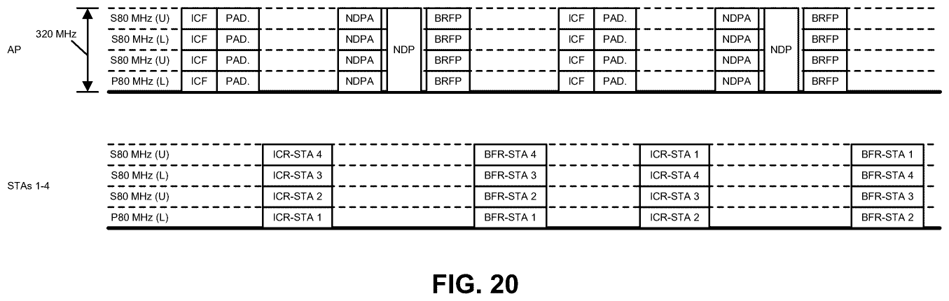

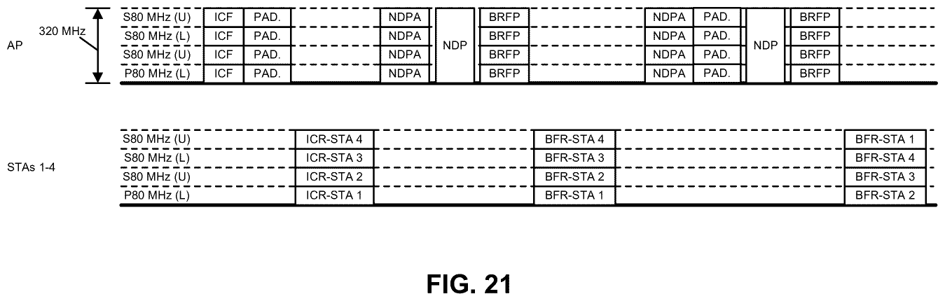

As shown in FIGS. 20-21, which present drawings illustrating examples of communication between the electronic devices of FIG. 1 or 2, sequential sounding can be used within a single TXOP to help decrease the overhead of sounding a DSO station over multiple DSO channels. An access point can meet the padding requirement of the DSO stations for channel switching by adding multiple dummy station information lists.

An alternative approach is to define padding in the UHR null data packet (NDP) announcement frame.

Note that in both the second option and the third option, the access point may need to store the 320 MHz (basic service set bandwidth) CQI report.

In FIG. 21, note that the ICF can indicate the number of sounding sequences, and the NDPA can announce the resource-unit location for a new sounding and the stations can use the padding time to switch to the corresponding subchannel.

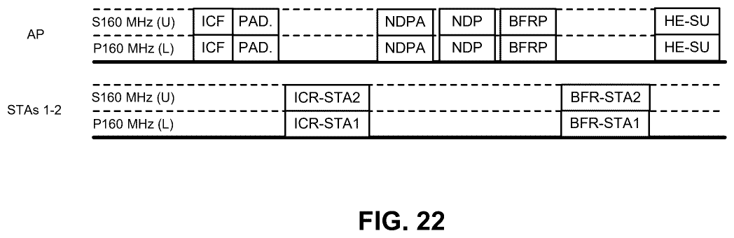

Moreover, FIG. 22, which presents a drawing illustrating an example of communication between the electronic devices of FIG. 1 or 2, shows beamforming in DSO. Notably, FIG. 22 shows a sounding sequence for high-efficiency (HE) single-user plus high-efficiency single-user format. For example, only the high-efficiency single-user plus high-efficiency single-user format can be used for downlink transmission in DSO with a high-efficiency station on a primary channel and one or more ultra-high reliability station stations on a DSO channel. In some embodiments, this format can include 80 MHz high-efficiency single user plus 80 MHz high-efficiency single user in a 160 MHz basic service set, and a 160 MHz high-efficiency single user plus 160 MHz high-efficiency single user in a 320 MHz basic service set.

When a high-efficiency station and a DSO station are required to be sounded together in a TXOP, a high-efficiency trigger-based sounding sequence may be needed to align a beamforming report (BFR) from the high-efficiency station and the DSO station. After the DSO station is switched to a secondary channel, an access point can send: a high-efficiency null data packet announcement (NDPA) (e.g., using a non-high throughput duplicate transmission) with a user information list including both the high-efficiency station and the DSO station; a null data packet in the high-efficiency single-user PPDU plus the high-efficiency single-user PPDU format on the primary and secondary channels; and a beamforming report (e.g., using a non-high throughput duplicate transmission) to trigger a high-efficiency trigger-based PPDU plus a high-efficiency trigger-based PPDU on a primary channel and a secondary channel.

Note that an access point can request full bandwidth feedback from a high-efficiency station (e.g., on the primary channel) and a DSO station (e.g., on a DSO channel), with the following settings for the bandwidth, resource-unit start index and resource-unit end index: the bandwidth of a high-efficiency NDPA can be 80 MHz when the access point is 160 MHz, and can be 160 MHz when the access point is 320 MHz; and a resource-unit start index may always be set to ‘0’, and a resource-unit end index can be set to ‘36’ for an 80 MHz station, and can be set to ‘73’ for a 160 MHz station. In some embodiments, a DSO station can consider resource-unit allocation in an NDPA and a beamforming report poll (BFRP) with reference to a channel that it has switched to based at least in part on the received ICF.

In some embodiments, group-address frame delivery in a multi-user PPDU is used for DSO stations. Notably, when DSO stations are scheduled on a DSO channel, an access point can assign one resource unit in a high-efficiency/high-throughput/extremely high-throughput/ultra-high reliability multi-user PPDU as the ‘broadcast resource unit’ for delivering the group-address frames. By default, the primary 20 MHz channel can be used for group-address frame delivery. In addition to broadcasting the resource unit on the primary 20 MHz of the high-efficiency/high-throughput/extremely high-throughput/ultra-high reliability multi-user PPDU, an access point can assign another 20 MHz resource unit on a DSO channel as a broadcast resource unit.

For example, the access point can deliver group-address frames to high-efficiency stations on the primary 20 MHz of a high-efficiency multi-user PPDU, and can deliver group-address frames to ultra-high reliability DSO stations on the 20 MHz broadcast resource unit on the DSO channel of a high-efficiency multi-user PPDU.

Alternatively, the access point can deliver group-address frames to extremely high-throughput stations on the primary 20 MHz of an extremely high-throughput multi-user PPDU, and can deliver group-address frames to ultra-high reliability DSO stations on the 20 MHz broadcast resource unit on the DSO channel of an extremely high-throughput multi-user PPDU.

In some embodiments, the access point can deliver group-address frames to extremely high-reliability stations, which do not support the DSO, on the primary 20 MHz of an ultra-high reliability multi-user PPDU, and can deliver group-address frames to ultra-high reliability DSO stations on the 20 MHz broadcast resource unit of an ultra-high reliability multi-user PPDU.

Note that the access point can assign a 20 MHz broadcast resource unit on a DSO channel in the high-efficiency/extremely high-throughput/ultra-high reliability multi-user PPDU when the frames are addressed to only DSO stations, which are scheduled on the DSO channel in the ICF.

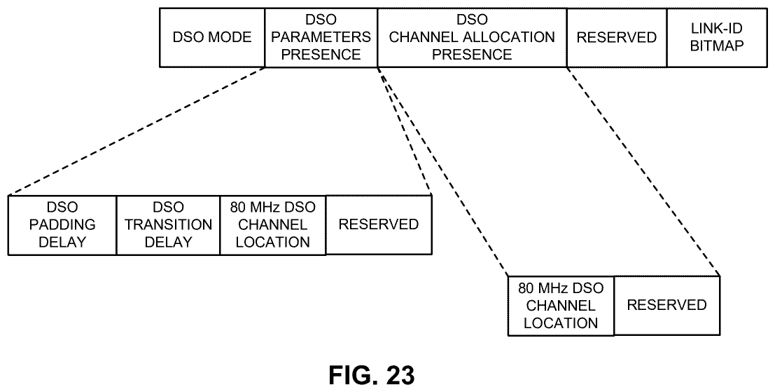

Furthermore, FIG. 23 presents a drawing illustrating an example of a DSO operating mode notification element. Notably, FIG. 23 shows an alternative option for enable/disable of DSO using multi-link enablement. Notably, a non-access point MLD can enable/disable the DSO mode over multiple links at the same time. Moreover, the non-access point MLD can use a DSO operating mode notification frame as the request and response. In the DSO operating mode notification frame, the DSO mode subfield (e.g., one bit) can be set to, e.g., ‘0’ to disable and can be set, e.g., to ‘1’ to enable the DSO mode. Moreover, the DSO parameters presence subfield (e.g., one bit) can be set, e.g., to ‘1’ by the non-access point station to indicate availability of DSO parameters. Furthermore, the DSO channel allocation presence subfield (e.g., one bit) can be set, e.g., to ‘1’ by an access point to indicate availability of DSO channel allocation. Additionally, the link-identifier bitmap subfield (e.g., 16 bits) can indicate the set of links where the DSO mode will be enabled. Note that the reserved subfield can include, e.g., six bits.

In some embodiments, the DSO parameters field can include: a DSO padding delay (e.g., five bits) and a DSO transition delay subfield (e.g., five bits) that indicates the DSO stations switching time between the primary channel and the DSO channel; and a number of 80 MHz DSO channels subfield (e.g., two bits) that indicates the number of DSO channels that the station supports on a 320 MHz basic service set bandwidth (for all links with a 320 MHz basic service set bandwidth). Note that the reserved subfield can include, e.g., four bits.

Moreover, the DSO channel allocation field (e.g., four bits) can include: an 80 MHz DSO channel location subfield that indicates the location of the 80 MHz DSO channels using, e.g., a 4-bit bitmap for DSO operation (for all links with a 320 MHz basic service set bandwidth). Note that the reserved subfield can include, e.g., four bits.

Note that a non-access point MLD can transmit the DSO operating mode notification frame as a request by setting the DSO Mode to, e.g., ‘1,’ setting a link-identifier bitmap to identify links that it wants to enable DSO, and setting the DSO parameters subfields. Upon receiving the request, an access point MLD can send a DSO operating mode notification frame as a response with the DSO mode set, e.g., to ‘1’ and allocating the DSO channels by setting the 80 MHz DSO channel allocation subfield. In some embodiments, when the basic service set bandwidth is 160 MHz or a station sets the ‘number of 80 MHz DSO channels’ to, e.g., ‘3’ in a 320 MHz basic service set bandwidth, an access point may not send the DSO operating mode notification frame as the response and only the request from the station can be sufficient for enabling the mode.

An alternative option for enable/disable of DSO can use multi-link enablement. Notably, in these embodiments, a DSO mode can be enabled for multiple links. However, there can be an extra delay because of the cross link processing delay at the access-point MLD level. After receiving the request for enabling the DSO mode (using the DSO operating mode notification frame), the access point can adopt a timeout value in which the DSO mode can be enabled after this timeout value.

Similar to the per-link DSO mode enablement, when the basic service set bandwidth is 320 MHz and the bandwidth of the DSO station is 80 MHz, the station may only support one DSO channel. These stations can make such a request by transmitting a DSO operating mode notification frame with an 80 MHz secondary DSO channel location that it wants to use as the DSO channel. Note that a similar accept or propose an alternative DSO channel negotiation can be used in this case.

We now describe embodiments of an 80 MHz DSO subband assignment in a 320 MHz BSS bandwidth. Notably, in first embodiments, the 80 MHz subband location is fixed and predefined (e.g., in a specification). Alternatively, in second embodiments, an access point can announce the 80 MHz subband location in an ultra-high reliability operation element by adding a DSO-related field. Moreover, in third embodiments, when enabling a DSO mode, a station can indicate its preferred location of a DSO subband in an ultra-high reliability operating mode notification request frame. An access point can indicate the assigned DSO subband in an ultra-high reliability operating mode notification response frame to a station based at least in part on the received ultra-high reliability operating mode notification request frame. Note that this option can provide more flexibility to the access point and the station to select the DSO subband. The access point can benefit from this by distributing the DSO subbands uniformly to DSO stations across a 320 MHz bandwidth.

Note that an association request frame, a reassociation request frame or a probe request frame can include information about ultra-high reliability capabilities after a last-assigned element. For example, an ultra-high reliability capabilities element can be present when a dot11UHROptionImplemented is ‘true.’ Otherwise, the ultra-high reliability capabilities element may not be present. The ultra-high reliability capabilities element: can have element identifier ‘255’; can have element identifier extension ‘ANA’; can be extensible; and may not be fragmentable.

Moreover, an association response frame, a reassociation response frame or a probe response frame can include information about ultra-high reliability capabilities after a last-assigned element. For example, an ultra-high reliability capabilities element can be present when a dot11UHROptionImplemented is ‘true.’ Otherwise, the ultra-high reliability capabilities element may not be present. Furthermore, the association response frame, the reassociation response frame or the probe response frame can include information about ultra-high reliability operation after the ultra-high reliability capabilities element. For example, an ultra-high reliability operation element can be present when a dot11UHROptionImplemented is ‘true.’ Otherwise, the ultra-high reliability operation element may not be present. The ultra-high reliability operation element: can have element identifier ‘255’; can have element identifier extension ‘ANA’; can be extensible; and may not be fragmentable.

The ultra-high reliability capabilities element format can include: an element identifier (e.g., having a length of one octet); a length (e.g., having a length of one octet); an element identifier extension (e.g., having a length of one octet); and/or ultra-high reliability MAC capabilities information. For example, a ‘1’ in bit zero (B0) of the ultra-high reliability MAC capabilities information field can indicate that DSO is supported. Otherwise, a ‘0’ in B0 of the ultra-high reliability MAC capabilities information field can indicate that DSO is not supported.

Moreover, the ultra-high reliability operation element format can include: an element identifier (e.g., having a length of one octet); a length (e.g., having a length of one octet); an element identifier extension (e.g., having a length of one octet); ultra-high reliability operation parameters; basic ultra-high reliability modulation coding scheme (MCS) and a number of spatial streams (NSS) set; ultra-high reliability operation information; and/or DSO operation information. For example, a ‘1’ in bit zero (B0) of the ultra-high reliability operation parameters field can indicate that the DSO operation information subfield is included in the ultra-high reliability operation information field. Otherwise, a ‘0’ in B0 of the ultra-high reliability operation parameters field can indicate that the DSO operation information subfield is not present in the ultra-high reliability operation information field. Furthermore, the DSO operation information field can include: a DSO transition timeout; and/or a DSO 80 MHz subband assignment. The DSO transition timeout subfield can include the timeout value for ultra-high reliability operating mode notification frame exchange to enable or disable the DSO mode. Additionally, the DSO 80 MHz subband assignment subfield can be present when a BSS bandwidth of an access point is 320 MHz. Otherwise, this subfield can be reserved. As discussed previously in the second embodiments, note that the DSO 80 MHz subband assignment subfield can be a bitmap used by an access point with a 320 MHz BSS bandwidth to announce the assignment of the DSO 80 MHz subbands to DSO station(s).

In some embodiments, a protected ultra-high-reliability action field can be used. The protected ultra-high reliability action field, in the octet immediately after the category field, can differentiate the protected ultra-high reliability action frame formats. The protected ultra-high reliability action field values associated with each frame format within the ultra-high reliability category can be 3-255. This information can indicate an ultra-high reliability operating mode notification. There may not be a time priority.

Moreover, an ultra-high reliability operating mode notification frame can be used. The ultra-high reliability operating mode notification frame can indicate that a non-access point station is changing its ultra-high reliability operation (e.g., to or from a DSO mode) and can be used by its associated station as a response to the received ultra-high reliability operating mode notification frame from the soliciting station. The action field of the ultra-high reliability operating mode notification frame can include: a category; a protected ultra-high reliability action; a dialog token; an ultra-high reliability control field; optional DSO operation parameters; and/or optional DSO 80 MHz subband assignment field.

Furthermore, the dialog token field can be set by a non-access point station to a nonzero value chosen by the station for sending a request and can be set by an access point to the value copied from the corresponding received ultra-high reliability operating mode notification frame for sending a response.

The ultra-high reliability control field format can include: a DUO mode (using B0); a DPS mode (using B1); a non-primary channel access (NPCA) mode (using B2); and/or a DSO mode (using B3). For a non-access point station, the DSO mode subfield can be: set to ‘0’ to indicate that the DSO mode is disabled for a non-access point station; or set to ‘1’ to indicate that the DSO mode is enabled for a non-access point station.

Additionally, the DSO operation parameters field can be optionally present when the ultra-high reliability operating mode notification frame is sent by a non-access point station and the DSO mode subfield of the ultra-high reliability control field is set to ‘1.’ Otherwise, it may not be present. The DSO 80 MHz subband assignment field can be optionally present when the ultra-high reliability operating mode notification frame is sent by an access point and the BSS bandwidth of the access point is 320 MHz. Otherwise, it may not be present.

As discussed previously in the third embodiments, the DSO operation parameters field can include: a DSO switch (or switching) delay; a DSO switch (or switching) back delay; and/or DSO 80 MHz subband selection. The DSO switch delay subfield can indicate the time required by a DSO station to switch from the primary subband to the DSO subband. Moreover, the DSO switch back delay subfield can indicate the time required by the DSO station to switch from the DSO subband to the primary subband. Note that the DSO 80 MHz subband selection subfield can be a bitmap that indicates the location of 80 MHz DSO subbands selected by the DSO station (for stations having an 80 MHz bandwidth) for DSO operation when the BSS bandwidth of their associated access point is 320 MHz. Otherwise, this subfield can be reserved.

Furthermore, in the third embodiments discussed previously, the DSO 80 MHz subband assignment field can include one or more bits. Note that the DSO 80 MHz subband assignment subfield can be a bitmap used by an access point with a 320 MHz BSS bandwidth to indicate the assignment of the DSO 80 MHz subbands to DSO station(s). Otherwise, this subfield can be reserved.

A non-access point station that supports DSO operation can enable the DSO mode when its associated access point supports DSO operation. When an ultra-high reliability non-access point station intends to enable the DSO mode with its associated access point, the non-access point station can transmit, to the access point, an ultra-high reliability operating mode notification frame with the DSO mode subfield of the ultra-high reliability control field of the frame set to ‘1’ and can include the DSO operation parameters field in the ultra-high reliability operating mode notification frame. As a response to the received ultra-high reliability operating mode notification frame, the access point can transmit, to the non-access point station, an ultra-high reliability operating mode notification frame, after the access point is ready to serve the non-access point station in the DSO operation and within the transition timeout interval. Alternatively or additionally, the transition timeout interval can be announced in the operation element by adding a DSO-related field.

Note that, when the BSS bandwidth is 320 MHz, an access point can include a DSO 80 MHz subband assignment field in the ultra-high reliability operating mode notification frame to indicate the location(s) of the 80 MHz DSO subband(s). The DSO non-access point station can perform DSO operations after transmitting an acknowledgement to the ultra-high reliability operating mode notification frame received from the access point.

Moreover, when an DSO non-access point station intends to disable the DSO mode, then the non-access point station can transmit, to its associated access point, an ultra-high reliability operating mode notification frame with the DSO mode subfield of the ultra-high reliability control field of the frame set to ‘0’ and may not include the DSO operation parameters field.

The associated access point can transmit, as a response to the received ultra-high reliability operating mode notification frame and in response to the non-access point station, an ultra-high reliability operating mode notification frame, after the access point is no longer serving the non-access point station in the DSO operation, within the transition timeout interval. Moreover, the DSO mode at non-access point station can be disable after transmitting an acknowledgement to the ultra-high reliability operating mode notification frame received from the access point.

In some embodiments, DSO can be used with EMLSR, DUO, DPS and/or coordinated beamforming (CBF). Regarding ICF and ICR: for DSO, BSRP can be the ICF option; for EMLSR, MU-RTS or BSRP can be the ICF options; for DUO, BSRP plus multi-station-block acknowledgment can be the option (note that BSRP plus non-high throughput DUP multi-station block acknowledgment can be used for the single-user case); for DPS, RTS, MU-RTS and BSRP can be allowed (although, in some embodiments BSRP plus non-high throughput DUP can be used); and for combinations of DSO plus EMLSR plus DUO plus DPS modes, when enabled by a non-access point station, BSRP plus a multi-station block acknowledgment can be used as the ICF or ICR.

Note that an access point that initiates a CBF TXOP may not allowed to use DSO operation. Moreover, CBF plus OFDMA may not be supported. Therefore, CBF plus DSO may also not be possible.

Regarding padding/switching and transition/switch-back delay of DSO, EMLSR and/or DPS combinations, the effective switching and switch back delay, when all these modes are enabled, can be based at least in part on the maximum values of the delay for all of these features.

Furthermore, regarding the switch back mechanism, the rules for switch back to listening operation or low capability mode for DSO, EMLSR and/or DPS can be the same. In a timer-based approach for EMLSR plus CBF, an EMLSR station may not follow the switch-back rule and may not switch back during a timeout interval. When the timer-based approach is adopted to other features (such as the sounding sequence in EMLSR and potentially in DSO and DPS) similar rules for switch back can be mandated for these features, so that these features can be used together.

In some embodiments, the communication techniques can be implemented in a physical layer and/or a MAC layer.

Note that the formats of packets or frames communicated during the communication techniques can include more or fewer bits, subfields or fields. Alternatively or additionally, the position of information in these packets or frames can be changed. Thus, the order of the subfields or fields can be changed.

While the preceding embodiments illustrate embodiments of the communication techniques using frequency subbands, in other embodiments the communication techniques can involve the concurrent use of different temporal slots, and/or or a combination of different frequency subbands, different frequency bands and/or different temporal slots. In some embodiments, the communication techniques can use OFDMA.

Moreover, while the preceding embodiments illustrated the use of Wi-Fi during the communication techniques, in other embodiments of the communication techniques Bluetooth or Bluetooth Low Energy is used to communicate at least a portion of the information in the communication techniques. Furthermore, the information communicated in the communication techniques can be communicated or can occur in one or more frequency bands, including: 900 MHz, a 2.4 GHz frequency band, a 5 GHz frequency band, a 6 GHz frequency band, a 60 GHz frequency band, a Citizens Broadband Radio Service (CBRS) frequency band, a band of frequencies used by LTE or another data communication protocol, etc.

As described herein, aspects of the present technology can include the gathering and use of data available from various sources, e.g., to improve or enhance functionality. The present disclosure contemplates that in some instances, this gathered data can include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure can broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

We now describe embodiments of an electronic device. FIG. 24 presents a block diagram of an electronic device 2400 (which can be a cellular telephone, a smartwatch, an access point, a wireless speaker, an IoT device, another electronic device, etc.) in accordance with some embodiments. This electronic device includes processing subsystem 2410, memory subsystem 2412 and networking subsystem 2414. Processing subsystem 2410 includes one or more devices configured to perform computational operations. For example, processing subsystem 2410 can include one or more microprocessors, application-specific integrated circuits (ASICs), microcontrollers, graphics processing units (GPUs), programmable-logic devices, and/or one or more digital signal processors (DSPs). In some embodiments, processing subsystem 2410 can include an interface circuit and a computation circuit.

Memory subsystem 2412 includes one or more devices for storing data and/or instructions for processing subsystem 2410, and/or networking subsystem 2414. For example, memory subsystem 2412 can include dynamic random access memory (DRAM), static random access memory (SRAM), a read-only memory (ROM), flash memory, and/or other types of memory. In some embodiments, instructions for processing subsystem 2410 in memory subsystem 2412 include: program instructions or sets of instructions (such as program instructions 2422 or operating system 2424), which can be executed by processing subsystem 2410. For example, a ROM can store programs, utilities or processes to be executed in a non-volatile manner, and DRAM can provide volatile data storage, and can store instructions related to the operation of electronic device 2400. Note that the one or more computer programs can constitute a computer-program mechanism, a computer-readable storage medium or software. Moreover, instructions in the various modules in memory subsystem 2412 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 2410. In some embodiments, the one or more computer programs are distributed over a network-coupled computer system so that the one or more computer programs are stored and executed in a distributed manner.

In addition, memory subsystem 2412 can include mechanisms for controlling access to the memory. In some embodiments, memory subsystem 2412 includes a memory hierarchy that includes one or more caches coupled to a memory in electronic device 2400. In some of these embodiments, one or more of the caches is located in processing subsystem 2410.

In some embodiments, memory subsystem 2412 is coupled to one or more high-capacity mass-storage devices (not shown). For example, memory subsystem 2412 can be coupled to a magnetic or optical drive, a solid-state drive, or another type of mass-storage device. In these embodiments, memory subsystem 2412 can be used by electronic device 2400 as fast-access storage for often-used data, while the mass-storage device is used to store less frequently used data.

Networking subsystem 2414 includes one or more devices configured to couple to and communicate on a wired and/or wireless network (i.e., to perform network operations), such as: control logic 2416, one or more interface circuits (or interface circuitry) 2418 and a set of antennas 2420 (or antenna elements) in an adaptive array that can be selectively turned on and/or off by control logic 2416 to create a variety of optional antenna patterns or ‘beam patterns.’ Alternatively, instead of the set of antennas, in some embodiments electronic device 2400 includes one or more nodes 2408, e.g., a pad or a connector, which can be coupled to the set of antennas 2420. Thus, electronic device 2400 may or may not include the set of antennas 2420. For example, networking subsystem 2414 can include a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 2414 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 2414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 2400 can use the mechanisms in networking subsystem 2414 for performing simple wireless communication between the electronic devices, e.g., transmitting advertising or frame frames and/or scanning for advertising frames transmitted by other electronic devices.

Within electronic device 2400, processing subsystem 2410, memory subsystem 2412 and networking subsystem 2414 are coupled together using bus 2428 that facilitates data transfer between these components. Bus 2428 can include an electrical, optical, and/or electro-optical connection that the subsystems can use to communicate commands and data among one another. Although only one bus 2428 is shown for clarity, different embodiments can include a different number or configuration of electrical, optical, and/or electro-optical connections among the subsystems.

In some embodiments, electronic device 2400 includes a display subsystem 2426 for displaying information on a display, which can include a display driver and the display, such as a liquid-crystal display, a multi-touch touchscreen, etc. Display subsystem 2426 can be controlled by processing subsystem 2410 to display information to a user (e.g., information relating to incoming, outgoing, or an active communication session).

Moreover, electronic device 2400 can also include a user-input subsystem 2430 that allows a user of the electronic device 2400 to interact with electronic device 2400. For example, user-input subsystem 2430 can take a variety of forms, such as: a button, keypad, dial, touch screen, audio input interface, visual/image capture input interface, input in the form of sensor data, etc.

Electronic device 2400 can be (or can be included in) any electronic device with at least one network interface. For example, electronic device 2400 can include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 2400, in alternative embodiments, different components and/or subsystems can be present in electronic device 2400. For example, electronic device 2400 can include one or more additional processing subsystems, memory subsystems, networking subsystems, and/or display subsystems. Additionally, one or more of the subsystems may not be present in electronic device 2400. Moreover, in some embodiments, electronic device 2400 can include one or more additional subsystems that are not shown in FIG. 24. In some embodiments, electronic device 2400 can include an analysis subsystem that performs at least some of the operations in the communication techniques. Also, although separate subsystems are shown in FIG. 24, in some embodiments some or all of a given subsystem or component can be integrated into one or more of the other subsystems or component(s) in electronic device 2400. For example, in some embodiments program instructions 2422 are included in operating system 2424 and/or control logic 2416 is included in the one or more interface circuits 2418.

Moreover, the circuits and components in electronic device 2400 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit can implement some or all of the functionality of networking subsystem 2414. This integrated circuit can include hardware and/or software mechanisms that are used for transmitting wireless signals from electronic device 2400 and receiving signals at electronic device 2400 from other electronic devices. Aside from the mechanisms herein described, radios are generally known in the art and hence are not described in detail. In general, networking subsystem 2414 and/or the integrated circuit can include any number of radios. Note that the radios in multiple-radio embodiments function in a similar way to the described single-radio embodiments.

In some embodiments, networking subsystem 2414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques can be used. Thus, the communication techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the communication techniques can be implemented using program instructions 2422, operating system 2424 (such as a driver for an interface circuit in networking subsystem 2414) or in firmware in an interface circuit networking subsystem 2414. Alternatively or additionally, at least some of the operations in the communication techniques can be implemented in a physical layer, such as hardware in an interface circuit or interface circuitry in networking subsystem 2414. In some embodiments, the communication techniques are implemented, at least in part, in a MAC layer and/or in a physical layer in an interface circuit in networking subsystem 2414.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

Moreover, while the preceding embodiments illustrated the use of wireless signals in one or more bands of frequencies, in other embodiments of the communication techniques electromagnetic signals in one or more different frequency bands are used. For example, these signals can be communicated in one or more bands of frequencies, including: a microwave frequency band, a radar frequency band, 900 MHz, 2.4 GHz, 5 GHz, 6 GHz, 60 GHz, and/or a band of frequencies used by a Citizens Broadband Radio Service or by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna node configured to communicatively couple to an antenna; and
an interface circuit, communicatively coupled to the antenna node, configured to communicate with a second electronic device, wherein the interface circuit is configured to:
generate, addressed to a second electronic device, an ultra-high reliability (UHR) operating mode notification frame, wherein the UHR operating mode notification frame comprises:
an indication that a dynamic subband operation (DSO) mode is enabled;
a second indication of whether a DSO parameter is present in the UHR operating mode notification frame; and
a third indication of whether a DSO channel allocation is present in the UHR operating mode notification frame.

2. The electronic device of claim 1, wherein the UHR operating mode notification frame comprises an action frame.

3. The electronic device of claim 1, wherein the electronic device comprises a non-access point station.

4. The electronic device of claim 3, wherein the DSO parameter comprises at least one of: a DSO padding; a DSO transition delay corresponding to a switching time of the second electronic device to a DSO channel; or a number of DSO channels having a bandwidth of 80 MHz in a bandwidth of 320 MHz.

5. The electronic device of claim 3, wherein the DSO channel allocation comprises a DSO channel location having a bandwidth of 80 MHz.

6. The electronic device of claim 5, wherein the DSO channel location is indicated with a bitmap.

7. The electronic device of claim 1, wherein the interface circuit is configured to receive, associated with the second electronic device, a second UHR operating mode notification frame as a response to the UHR operating mode notification frame that confirms the DSO mode.

8. The electronic device of claim 1, wherein, when a basic service set bandwidth equals 160 MHz or a number of DSO channels having a bandwidth of 80 MHz equals 3 in a basic service set bandwidth of 320 MHz, the UHR operating mode notification frame enables the DSO mode without a subsequent response.

9. The electronic device of claim 1, wherein, prior to generating the UHR operating mode notification frame, the interface circuit is configured to receive, associated with the second electronic device, a probe response, an association response or a re-association response;
wherein the probe response, the association response or the re-association response comprises a UHR operating element; and
wherein the UHR operating element comprises: a DSO transition timeout, and a DSO 80 MHz subband assignment.

10. The electronic device of claim 9, wherein, after the DSO transition timeout has elapsed, the DSO mode is enabled.

11. The electronic device of claim 1, wherein, when a basic service set bandwidth is 320 MHz and a DSO channel bandwidth is 80 MHz, the electronic device is configured to support one DSO channel.

12. The electronic device of claim 1, wherein the UHR operating mode notification frame specifies a DSO channel location having a bandwidth of 80 MHz.

13. The electronic device of claim 1, wherein the interface circuit is configured to receive, associated with the second electronic device, a second UHR operating mode notification frame as a response to the UHR operating mode notification frame; and wherein the DSO mode is enabled based at least in part on the second UHR operating mode notification frame.

14. The electronic device of claim 13, wherein the second UHR operating mode notification frame specifies a DSO 80 MHz subband assignment.

15. The electronic device of claim 1, wherein, when the second electronic device stops a transmit opportunity, the interface circuit is configured to return to a primary channel having a bandwidth of 80 MHz or 160 MHz and experiences a blindness having a predefined duration.

16. The electronic device of claim 1, wherein the interface circuit is configured to puncture one or more channels having a 20 MHz bandwidth and the DSO mode does not use the one or more punctured channels.

17. A processor, comprising:
an interface circuit;
a computation circuit coupled to the interface circuit, wherein the computation circuit is configured to:
generate, addressed to an electronic device, an ultra-high reliability (UHR) operating mode notification frame, wherein the UHR operating mode notification frame comprises:
an indication that a dynamic subband operation (DSO) mode is enabled;
a second indication of whether a DSO parameter is present in the UHR operating mode notification frame; and
a third indication of whether a DSO channel allocation is present in the UHR operating mode notification frame.

18. The processor of claim 17, wherein the UHR operating mode notification frame comprises an action frame.

19. A method for generating an ultra-high reliability (UHR) operating mode notification frame, comprising:
by an electronic device:
generating, addressed to a second electronic device, an ultra-high reliability (UHR) operating mode notification frame, wherein the UHR operating mode notification frame comprises:
an indication that a dynamic subband operation (DSO) mode is enabled;
a second indication of whether a DSO parameter is present in the UHR operating mode notification frame; and
a third indication of whether a DSO channel allocation is present in the UHR operating mode notification frame; and
receiving, associated with the second electronic device, a second UHR operating mode notification frame as a response to the UHR operating mode notification frame that confirms the DSO mode.

20. The method of claim 19, wherein, prior to generating the UHR operating mode notification frame, the method comprises receiving, associated with the second electronic device, a probe response, an association response or a re-association response;
wherein the probe response, the association response or the re-association response comprises a UHR operating element; and
wherein the UHR operating element comprises: a DSO transition timeout, and a DSO 80 MHz subband assignment.
